(19) United States
(12) Patent Application Publication
(10) Pub. No.: US 2014/0018486 A1
(43) Pub. Date: Jan. 16, 2014

(54) USE OF A COMB POLYMER FOR PREPARING A SUSPENSION COMPRISING CALCIUM CARBONATE AND HAVING A SENSITIVITY TO REDUCED TEMPERATURE

(71) Applicant: COATEX S.A.S., Genay (FR)

(72) Inventors: Christian Jacquemet, Lyon (FR); Jacques Mongoin, Quiniceux (FR); Jean-Marc Suau, Lucenay (FR)

(21) Appl. No.: 13/937,295

(22) Filed: Jul. 9, 2013

Related U.S. Application Data
(60) Provisional application No. 61/673,741, filed on Jul. 20, 2012.

(30) Foreign Application Priority Data
Jul. 13, 2012 (FR) 12 56803

(51) Int. Cl. C08K 3/26; C08F 220/06

(52) U.S. Cl. CPC C08K 3/26; C08F 220/06
USPC 524/425; 526/273

(57) ABSTRACT

The invention relates to the use of a comb polymer for preparing a slurry, said slurry comprising calcium carbonate, the viscosity of said aqueous slurry as measured by a HAAKE Rheostress rheometer ranging from 25 to 1000 mPa·s measured at 20° C. and at 90° C.

### REFERENCE TO PRIOR APPLICATIONS

This application claims priority to U.S. provisional application Ser. No. 61/673,741, filed Jul. 20, 2012; and to French patent application 12 56803, filed Jul. 13, 2012, both incorporated herein by reference.

The present invention relates to the use of a comb copolymer in the preparation of an aqueous slurry comprising calcium carbonate, said slurry showing a reduced temperature sensitivity.

Nowadays, the industry is required to provide slurries of calcium carbonate for wide variety of applications. Slurries of calcium carbonate are suspensions of insoluble solids in a liquid medium which is generally a mix of water with at least one additive. The precise composition of the slurry, e.g. the particle size of the calcium carbonate product or the nature of the additive in the slurry, depends on its intended use. Slurries of calcium carbonate are indeed used in a wide variety of applications including paper, paint, plastic and concrete.

The preparation of slurries of calcium carbonate generally involves milling and/or dispersing processes. Reducing the particle size of the calcium carbonate product generally requires the use of intensive energy mixing means. The slurry can thus get very hot due to energy induced by shear grinders and dispersers. For example the temperatures can get up to 65° C. and far above, e.g. between 70° C. and 105° C.

At such temperatures, the viscosity of the slurries can increase dramatically, then leading to slurries no longer processable. Additives must be used to avoid this problem.

However, if the additives used to control the viscosity deteriorate at these high temperatures, the particles of calcium carbonate flocculate and the machines get blocked. There is then a high risk of damaging production units, such as grinding units. To avoid such a situation, it is necessary to continuously cool the equipment. This can be nevertheless very costly.

Therefore, there is a need for improved additives that control, reduce, or prevent the viscosity increase of slurries comprising calcium carbonate at elevated temperatures, e.g. at temperatures above 65° C. that is to say additives useful to reduce temperature sensitivity of slurries containing calcium carbonate.

Furthermore, it would be desirable to provide additives that stabilize aqueous slurries containing high solids calcium carbonate at elevated temperatures.

Another object of the present invention is to provide additives that will be compatible in paper, paint, plastic and concrete formulations.

It has been found that the above-mentioned objects are solved by the use of a comb copolymer in the preparation of an aqueous slurry with reduced temperature sensitivity, said slurry comprising a calcium carbonate, the viscosity of said aqueous slurry as measured at 20 s⁻¹ by a HAAKE Rheostress rheometer ranging from 25 and 1000 mPa·s measured at 20° C. and at 90° C.,
wherein the specific viscosity of said polymer measured at 20° C. and at a polymer concentration of 45 g/l differs from the specific viscosity of said polymer measured at 70° C. by a specific viscosity difference Δηₛₚ, wherein the absolute value of Δηₛₚ is less than or equal to 0.5,
wherein said polymer does not have a cloud point between 20° C. and 95° C. measured in water, and
wherein said polymer has a specific charge from −10 C/g to −600 C/g at pH 8.

The inventors have indeed surprisingly found that the use of a comb polymer having a combination of the above-mentioned three characteristics (a specific viscosity difference Δηₛₚ, no cloud point in a defined temperature range and a specific charge in a defined range) is especially advantageous to provide aqueous slurries containing calcium carbonate with reduced temperature sensitivity. The comb polymers with the aforementioned characteristics can reduce the heat sensitivity of such a slurry and prevent an unwanted viscosity increase of the slurry. For example, according to the invention, comb polymers prevent the aqueous slurry from reaching to a viscosity above 1000 mPa·s (HAAKE Rheostress rheometer at 20 s⁻¹) during production and then application, stages that may occur at elevated temperatures, e.g. at temperatures above 65° C., for example at 90° C. when finished product is out of the grinder.

Weakly anionic and water-soluble copolymers are described in WO 01/96007. These polymers are presented as enabling to obtain aqueous suspensions of mineral pigments and/or fillers with a moderate to high mineral matter content, stable over time, without sedimentation, weakly sensitive to pH and ionic strength of the media used in the papermaking or petroleum formulations, and having a low Zeta potential. These polymers are not described as useful in the preparation of a calcium carbonate aqueous slurry with reduced temperature sensitivity, more precisely with a viscosity between 25 and 1000 mPa·s as measured at 20° C. and 90° C. We can note that no slurry viscosity measurement is made at a high temperature, i.e. 90° C., and that no specific viscosity measurement of the copolymer is made at a high temperature, i.e. 70° C., thus that no calculation of specific viscosity difference is made in this document. In addition, the copolymers described in this application may result from the polymerization of an anionic monomer with a phosphoric function, which is t regarded as non desirable in terms of environmental pollution. Also, some of the copolymers described in this application include cross-linking monomers, which are also not desirable in the context of the present invention for rheology reasons. Still others copolymers of this application include acrylamide compounds which are today regarded as potentially toxic for human beings and animals.

For the purpose of the present invention, the term “calcium carbonate” refers to a material that comprises at least 80 wt. % calcium carbonate. The term “calcium carbonate” comprises ground calcium carbonate (GCC), that-is-to-say a calcium carbonate obtained from natural sources, such as limestone, marble, calcite or chalk, as well as precipitated calcium carbonate (PCC), that-is-to-say a synthesized material, generally obtained by precipitation following a reaction of carbon dioxide and calcium hydroxide (hydrated lime) in an aqueous environment or by precipitation of a calcium- and a carbonate source in water. Additionally, precipitated calcium carbonate can also be the product of calcium and carbonate salts introduction, of calcium chloride and sodium carbonate for example, in an aqueous environment. PCC may be vaterite, calcite or aragonite. The calcium carbonate component may be a ground calcium carbonate which has been obtained by wet grinding of a calcium carbonate.

According to the present invention, the term “slurry” means a water suspension that comprises insoluble solids and optionally at least one additive.

According to the present invention, the term “reduced temperature sensitivity” means that the viscosity of the slurry is maintained between 25 and 1000 mPa·s, when measured by a HAAKE Rheostress rheometer at 20 s⁻¹ at 20° C. and at 90° C., that is to say when the slurry is exposed to high temperatures. “High temperature” means temperature above 60° C. and more preferably temperature between 65 and 105° C., for example 90° C. “Stabilizing” or “stabilization” means that the viscosity of the slurry is maintained between 25 and 1000 mPa·s, when the slurry is exposed to a temperature above 60° C. and more preferably to a temperature between 65 and 105° C.

According to the present invention, the aqueous slurry with reduced temperature sensitivity comprising a calcium carbonate and at least one comb copolymer according to the present invention, has a viscosity as measured by a HAAKE Rheostress rheometer at 20 s⁻¹ which is between 25 and 1000 mPa·s measured at 20° C. and at 90° C. It is to be noted that at viscosity values over 1000 mPa·s there is a risk of blocking and damaging production units, such as grinding units. It is thus an object of the present invention to keep viscosities of the slurry below 1000 mPa·s not only at room temperature, but also at higher temperatures.

For the purpose of the present invention, the term “comb copolymer” refers to a copolymer composed of a main chain, also referred to as backbone, and of branched comb macromonomers.

According to a first aspect of the invention, the specific viscosity of the comb copolymer measured at 20° C. at a polymer concentration of 45 g/l differs from the specific viscosity of said polymer measured at 70° C. by a specific viscosity difference Δηₛₚ, such that the absolute value of Δηₛₚ is less than or equal to 0.5.

The term “specific viscosity difference” in the meaning of the present invention is defined as the difference of the specific viscosities measured at 70° C. and at 20° C.

Δηₛₚ=η_{sp70° C.}−η_{sp20° C.}

The term “specific viscosity” in the context of the present invention is defined as the difference of the relative viscosity as measured at a determined temperature (e.g. 20° C. and 70° C.) minus 1.

ηₛₚ=ηᵣₑₗ−1

The relative viscosity as used herein is the quotient of the solution viscosity η and the solvent viscosity η₀

$${η}_{rel} = \frac{η}{{η}_{0}}$$

wherein the solvent viscosity η₀ is defined as the viscosity of the pure solvent at a determined temperature (e.g. 20° C. or 70° C.) and the solution viscosity η is defined as the viscosity of the comb copolymer dissolved in the pure solvent at a determined temperature (e.g. 20° C. or 70° C.) and at a determined polymer concentration (e.g. 45 g/l).

However, to determine the relative viscosity it is sufficient to measure the flow time t (of the solution) and t₀ (of the solvent) at a given temperature (e.g. 20° C. or 70° C.) if the boundary conditions are constant. Therefore, the relative viscosity may be defined as

$${η}_{rel} = \frac{t}{{t}_{0}}$$

and, thus, the specific viscosity may be defined as:

$${η}_{sp} = \frac{t}{{t}_{0}} - 1$$

The term “specific viscosity difference” in the context of the present invention is defined as the difference of the specific viscosities measured at 70° C. and at 20° C.

Δηₛₚ=η_{sp70° C.}−η_{sp20° C.}

The specific viscosity of the polymer is obtained from an aqueous polymer solution with a polymer concentration of 45 g/l in water. The flow times t and t₀ were measured at 20° C. and at 70° C. and ηₛₚ and Δηₛₚ are calculated according to the above mentioned formulas.

According to a second aspect of the present invention, the comb copolymer does not have a cloud point between 20° C. and 95° C. measured in water.

The “cloud point of the polymer” is the temperature at which polymers dissolved in water are no longer completely soluble at atmospheric pressure but precipitate, giving the water a cloudy appearance.

According to a third aspect of the invention, the comb copolymer has a specific charge from −10 C/g to −600 C/g at pH 8.

This means that the comb copolymer according to the present invention is an anionically charged comb copolymer, that-is-to-say that the total or net charge (i.e. the sum of all positive and negative charges) of the copolymer is negative.

According to one embodiment of the invention, said copolymer has a specific charge from −10 C/g to −550 C/g at pH 8.

According to another embodiment of the invention, said copolymer has a specific charge from −100 C/g to −550 C/g at pH 8.

According to still another embodiment of the invention, said copolymer has a specific charge from −200 C/g to −550 C/g at pH 8.

According to one embodiment of the present invention, the comb copolymer is a synthetic polymer with anionic charge on the backbone and non-charged side chains. According to this aspect, the side chains of the anionically charged comb polymer may comprise polymerized epoxide-containing compounds, such as, for example, ethylene oxide, propylene oxide, 1-butylene oxide. It is preferred that the polyether side chains comprise polyethylene oxide or polypropylene oxide or a mixed copolymer comprising ethylene oxide and propylene oxide and have at their free end a hydroxyl group or an alkyl group having between 1 and 4 carbon atoms, being a straight or branched chain.

According to one another embodiment of the invention, the comb copolymer consists in:
a) at least one monomer which is acrylic acid and/or methacrylic acid, and
b) at least one macromonomer of formula (I):

R-X-R′ (I)
X represents m units of propylene oxide (PO) and n units of ethylene oxide (EO), said units of PO and EO being disposed either randomly or regularly, wherein m and n are integers less than or equal to 150, with at least one of them being a non-zero,
R designates a polymerizable unsaturated function,
R′ represents hydrogen or an alkyl group from 1 to 4 carbon atoms.

According to one embodiment of the present invention, the comb copolymer is such that R in the macromonomer of formula (I) designates the methacrylate function, the methacrylurethane function, the acrylate function, the vinyl function or the allyl function.

According to one another embodiment of the present invention, the comb copolymer consists in, expressed as a percentage by weight of each of its components:
a) from 5 to 60% of at least one monomer which is acrylic acid and/or methacrylic acid, and
b) from 40 to 95% of one macromonomer of formula (I).

According to still one another embodiment of the present invention, the comb copolymer consists in:
a) monomers of acrylic acid,
b) monomers of methacrylic acid, and
c) macromonomers with the formula (I),
wherein the percentage by weight of monomers of acrylic acid is less than the percentage by weight of monomers of methacrylic acid.

According to this embodiment of the present invention, the inventors have indeed realized that to solve the above-mentioned problem of providing aqueous slurries containing calcium carbonate with reduced temperature sensitivity, it is advantageous to use a comb copolymer having:
a negatively-charged backbone consisting in randomly polymerized monomers of acrylic acid and methacrylic acid and wherein the percentage by weight of monomers of methacrylic acid is higher than the percentage by weight of monomers of acrylic acid and
non-charged side chains consisting in polymerized epoxide-containing compounds.

It is known that homopolymers of acrylic acid are more efficient to disperse pigments than homopolymers of methacrylic acids. Surprisingly, according to this embodiment of the invention, the comb copolymers having a negatively-charged backbone consisting in randomly polymerized monomers of acrylic acid and methacrylic acid and wherein the percentage by weight of monomers of methacrylic acid is higher than the percentage by weight of monomers of acrylic acid, show better efficiency to reduce temperature sensitivity of calcium carbonate slurries, the viscosity of said slurry as measured by a HAAKE Rheostress rheometer at 20 s⁻¹ being between 25 and 1000 mPa·s measured at 20° C. and at 90° C.

According to one embodiment of the present invention, the comb copolymer used in the preparation of an aqueous slurry with reduced temperature sensitivity, said slurry comprising a calcium carbonate, the viscosity of said slurry as measured by a HAAKE Rheostress rheometer at 20 s⁻¹ ranging from 25 and 1000 mPa·s measured at 20° C. and at 90° C.
wherein the specific viscosity of said polymer measured at 20° C. and at a polymer concentration of 45 g/l differs from the specific viscosity of said polymer measured at 70° C. by a specific viscosity difference Δηₛₚ, such that the absolute value of Δηₛₚ is less than or equal to 0.5.
wherein said polymer does not have a cloud point between 20° C. and 95° C. measured in water, and
wherein said polymer has a specific charge from −10 C/g to −600 C/g at pH 8, said copolymer consisting in:
   A1) monomers of acrylic acid,
   A2) monomers of methacrylic acid, and
   B) macromonomers of formula (I),

R-X-R′ (I)
in which:
   X represents m units of propylene oxide (PO) and n units of ethylene oxide (EO), said units of PO and EU being disposed either randomly or regularly, wherein m and n are integers less than or equal to 150, with at least one of them being a non-zero,
      R designates a polymerizable unsaturated function,
      R′ represents hydrogen or an alkyl group from 1 to 4 carbon atoms.

Said copolymer is such that the percentage by weight of monomers of acrylic acid is less than the percentage by weight of monomers of methacrylic acid.

According to one embodiment of the present invention, the comb copolymer consists in, expressed as a percentage by weight of each of its components:
A1) from 1 to 10% of monomers of acrylic acid,
A2) from 10 to 50% of monomers of methacrylic acid, and
B) from 40 to 90% of macromonomers of formula (I).

According to one embodiment of the present invention, the comb copolymer consists in, expressed as a percentage by weight of each of its components:
A1) from 1 to 8% of monomers of acrylic acid,
A2) from 30 to 50% of monomers of methacrylic acid, and
B) from 40 to 70% of macromonomers of formula (I).

According to one embodiment of the present invention, the comb copolymer consists in, expressed as a percentage by weight of each of its components:
A1) from 3 to 6% of monomers of acrylic acid,
A2) from 20 to 25% of monomers of methacrylic acid, and
B) from 70 to 77% of macromonomers of formula (I).

According to one another embodiment of the present invention, the comb copolymer consists in, expressed as a percentage by weight of each of its components:
A1) from 3 to 6% of monomers of acrylic acid,
A2) from 30 to 35% of monomers of methacrylic acid, and
B) from 60 to 67% of macromonomers of formula (I).

According to one embodiment of the present invention, the comb copolymer is such that m in the macromonomer with formula (I) ranges between 0 and 10.

According to one embodiment of the present invention, the comb copolymer is such that n in the macromonomer with formula (I) ranges between 10 and 150.

According to one embodiment of the present invention, the comb copolymer is such that n and m in the macromonomer with formula (I) are such that n+m is more than or equal to 17.

According to one embodiment of the present invention, the comb copolymer has a molecular weight below 100 000 g/mol, for example between 10 000 and 100 000 g/mol, for example between 10 000 and 40 000 g/mol, for example between 10 000 and 20 000 g/mol.

Said copolymer is obtained by the known methods of conventional free radical copolymerization in solution, in bulk, in direct or inverse emulsion, in suspension or precipitation in suitable solvents, in the presence of known catalytic systems and transfer agents, or again, by processes of controlled radical polymerization such as the method known as Reversible Addition Fragmentation Transfer (RAFT), the method known as Atom Transfer Radical Polymerization (ATRP), the method known as Nitroxide Mediated Polymerization (NMP), or again, the method referred to as Cobaloxime Mediated Free Radical Polymerization.

It is obtained in the acid and possibly distilled form. It can also be partially or totally neutralized by one or more neutralization agents selected from the hydroxides of sodium, calcium, magnesium and potassium and their mixtures or selected from the amines.

According to one embodiment of the present invention, said comb copolymer is partially or totally neutralized.

According to one another embodiment of the present invention, said copolymer is 100% neutralized with sodium hydroxide.

In the context of the present invention, it is to be noted that the different embodiments may be combined with each other.

According to one embodiment, the comb polymer is present in an amount from 0.01 to 10 wt. %, based on the total weight of the solids in the slurry, for example from 0.05 to 5 wt. %, or for example from 0.1 to 3.0 wt. %, or for example from 0.2 to 2.0 wt. %, or for example from 0.25 to 1.5 wt. % or for example from 0.5 to 1.25 wt. %.

According to another embodiment, the aqueous slurry according to the present invention consists in water, a calcium carbonate as defined above and a comb copolymer according to the present invention. According to this embodiment, the aqueous slurry does not contain any other additive than the comb copolymer described in the present application, thus it does not comprise for example another polymer or dispersant.

The calcium carbonate aqueous slurry may be obtained by a method comprising 1/a step of dispersion and 2/a step of grinding. Alternatively, the calcium carbonate aqueous slurry may be obtained by a method comprising 1/a step of grinding and 2/a step of dispersing. According to another method, the calcium carbonate aqueous slurry may be obtained by a method comprising 1/a step of grinding until a determined solid content SC1 and a determined particle size distribution PSD1, 2/a step of dispersing and 3/a step of grinding until a determined solid content SC2 and a determined particle size distribution PSD2. According to another method, the step of dispersing and the step of mixing may be carried out at the same time.

The step of dispersion consists in preparing, under agitation, a suspension of calcium carbonate. More precisely, it may notably consist in introducing all or part of the comb copolymer according to the invention into the aqueous phase (i.e. water), and then the calcium carbonate, so as to obtain an aqueous suspension with a determined calcium carbonate content. In other words, the step of dispersion may consist in mixing the at least one comb copolymer with water, then mixing the calcium carbonate component with the comb copolymer solution. Alternatively, it may consist in introducing all or part of the calcium carbonate into the aqueous phase (i.e. water), and then the comb copolymer according to the invention. In this case, the step of dispersion consist in mixing the calcium carbonate component with water, then mixing the at least one comb copolymer with the calcium carbonate suspension.

The step of dispersion may be carried out into a mixer or into any other equipment which has the ability to homogeneously mix or homogenize the components of the slurry. The skilled person will adapt to these mixing and/or homogenizing conditions such as the mixing speed and temperature, and according to the available process equipment.

The term “grinding” means that the mineral particles are divided into smaller particles. The step of grinding may take place into a mill or into any other equipment which has the ability to divide particles of calcium carbonate into smaller particles.

The step of dispersing and the step of mixing may be carried out at room temperature, i.e. at 20° C. or at other temperatures, for example at temperatures varying between 5 and 140° C. Heat may be introduced by internal shear or by an external source or a combination thereof.

The method of preparation of a calcium carbonate aqueous slurry may also comprise a step of concentration. The term “concentration” means lowering the water content of the slurry, so as to adjust the solids content of the aqueous slurry. The step of concentration may be performed by the methods known by the skilled person. It may notably be performed by thermal means, for example by means of an evaporator or any other adapted evaporation equipment.

The calcium carbonate aqueous slurry may be dried with any suitable method known in the art. It may notably be thermally dried, for example by means of a spray drier, or it may mechanically dried, for example by means of filters.

According to one embodiment, the aqueous slurry is a high solid containing aqueous slurry, e.g. a slurry having a solid content of at least 45 wt. % based on the total weight of the aqueous slurry. According to a preferred embodiment, the aqueous slurry according to the present invention has a solid content from 45 to 82 wt. %, preferably from 60 to 78 wt. %, and more preferably from 70 to 78 wt. %, based on the total weight of the aqueous slurry.

According to one embodiment of the invention, the comb polymers is used in the preparation of a slurry having a particle size distribution such that about 60% by weight of the particles have an equivalent diameter of less than or equal to 2 μm.

According to one embodiment of the present invention, the aqueous slurry has a pH ranging from 7 to 12.

According to one embodiment of the present invention, the amount of said comb copolymer is calculated such that the aqueous slurry containing calcium carbonate has a viscosity as measured by an HAAKE Rheostress rheometer at 20 s⁻¹ between 25 and 800 mPa·s measured at 20° C. and at 90° C., for example between 30 to 500 mPa·s at 20° C. and at 90° C., or for example between 35 to 300 mPa·s measured at 20° C. and at 90° C.

According to one embodiment, no additive, e.g. dispersant, having a specific charge of more than −500 C/g at pH 8 is added to the aqueous slurry.

The aqueous slurry of the present invention thus obtained can be used in numerous applications such as in paper, plastics, paint, and/or concrete applications.

Another object of the present invention is a comb copolymer for use in the preparation of an aqueous slurry with reduced temperature sensitivity, said slurry comprising a calcium carbonate, the viscosity of said aqueous slurry as measured by a HAAKE Rheostress rheometer at 20 s⁻¹ being between 25 and 1000 mPa·s measured at 20° C. and at 90° C.,
wherein the specific viscosity of said copolymer measured at 20° C. and at a copolymer concentration of 45 g/l differs from the specific viscosity of said copolymer measured at 70° C. by a specific viscosity difference Δηₛₚ, wherein the absolute value of Δηₛₚ is less than or equal to 0.5,
wherein said copolymer does not have a cloud point between 20° C. and 95° C. measured in water, and
wherein said copolymer has a specific charge from −10 C/g to −600 C/g at pH 8.

Another object of the present invention is a comb copolymer comprising:
a) at least one monomer which is acrylic acid and/or methacrylic acid, and
b) at least one macromonomer with the formula (I):

R-X-R′ (I)
X represents m units of propylene oxide (PO) and n units of ethylene oxide (EO), said units of PO and EO being disposed either randomly or regularly, wherein m and n are integers less than or equal to 150, with at least one of them being a non-zero,
R designates a polymerizable unsaturated function,

R′ represents hydrogen or an alkyl group with from 1 to 4 carbon atoms.

Another object of the present invention is a comb copolymer consisting in:
A1) at least one monomer which is acrylic acid,
A2) at least one monomer which is methacrylic acid, and
B) at least one macromonomer with the formula (I):

R-X-R′ (I)
X represents m units of propylene oxide (PO) and n units of ethylene oxide (EO), said units of PO and EO being disposed either randomly or regularly, wherein m and n are integers less than or equal to 150, with at least one of them being a non-zero,
R designates a polymerizable unsaturated function,
R′ represents hydrogen or an alkyl group with from 1 to 4 carbon atoms,
wherein the percentage by weight of monomers of acrylic acid is less than the percentage by weight of monomers of methacrylic acid.

### EXAMPLES

The specific charge of the exemplified polymers is measured by the cationic polymer demand that is necessary to achieve a charge value of zero, as detected through polyelectrolyte titration until the charge neutral point 0 mV. The equipment necessary to achieve the measurement consists in the MüteK PCD-02 and the MüteK PCD-03 detector. If necessary, the sample is adjusted to pH 8.0±0.1 with NaOH (0.1M) prior to measurement. This method is designed for the charge detection (result in ml) of an aqueous sample and the calculation to the specific charge quantity (unit: C/g). The cationic reagent used to perform the measurement is (0.001 N) poly-diallyl-dimethyl-ammonium-chloride (Poly-DADMAC).

The cloud point of the exemplified polymers is measured by a turbidity test, in an aqueous 0.2 mol/l NaCl solution adjusted to pH 10 with NaOH (polymer concentration 45 g/l). The test tube is immersed in an oil bath the temperature of which is adjusted. Once the targeted temperature is reached, the temperature is maintained at a constant level for at least 15 minutes. Then the test tube is removed from the bath and the turbidity is immediately evaluated visually.

The specific viscosity difference is determined by a Lauda PVS system, on aqueous polymer solutions (polymer concentration 45 g/l). Measurements are performed with a capillary Hubbelohde DIN (Schott) of type I (K=0.010).

The copolymer molecular mass, according to the invention is determined by steric exclusion chromatography.

Copolymers, according to the invention, are prepared according to recognized methods of radical copolymerization.

A preparation method example is described below in example 1.

### Example 1

This example illustrates the use of different polymers (tests 1 to 7) in the preparation of a ground calcium carbonate aqueous slurry (GCC) at 71% solid content with a particle size distribution such that about 60±1% by weight of the particles have an equivalent spherical diameter less than 2 μm.

Test 1 illustrates the use of a homopolymer of acrylic acid with a specific charge which is not set between −10 C/g and −600 C/g at pH 8.

We use a homopolymer of acrylic acid 100% neutralized with sodium hydroxide (molecular weight: 5600 g/mol), commercially available under the name of Rheosperse® 3030 (Coatex Company France).

Test 2 to 5 illustrate the use of a comb copolymer according to the invention having the combination of the three claimed features (specific viscosity difference, no cloud point between 20° C. and 95° C., a specific charge from −10 to −600 C/g à pH 8) and having:
a negatively-charged backbone consisting in randomly polymerized monomers of acrylic acid and methacrylic acid and wherein the percentage by weight of monomers of methacrylic acid is higher than the percentage by weight of monomers of acrylic acid and
non-charged side chains consisting in polymerized epoxide-containing compounds.

More precisely:
Test 2: comb copolymer 100% neutralized with sodium hydroxide (molecular weight: 12 900 g/mol)
The polymer has the following composition (in % by weight):
   7.3% of monomers of acrylic acid,
   47.3% of monomers of methacrylic acid, and
   45.4% of macromonomers which are a methacrylic ester of poly (ethylene oxide) with an average molecular weight of 750 g/mol and having a methyl group at the stage of the end chain.

The process for preparing this copolymer is the following one:

In a 1 L glass reactor equipped with mechanical stirring and a thermal regulation system, 243 g of water is weighted.

In a first beaker, are weighted: 15.18 g of acrylic acid, 98.38 g of methacrylic acid, 94.43 g of methacylate of poly(oxyethylene) having a molecular weight of 750 g/mol and having a methyl group at the end of the terminal chain and 147.69 g of water.

In a second beaker 5.7 g of dimercapto-1,8-dioxa-3,6-octane is weighted.

In a third beaker are weighted 5.886 g of ammonium persulfate and 50 g of water.

The reactor is heated to 86° C. and the additives of the three beakers are continuously added using three pumps in three hours. The mixture is then cooked for 1 hour and then neutralized with NaOH until pH 8.

The others copolymers exemplified hereafter are prepared according to a similar process.
Test 3: comb copolymer 100% neutralized with sodium hydroxide (molecular weight: 17 900 g/mol)
The polymer has the following composition (in % by weight):
   4.7% of monomers of acrylic acid,
   31.7% of monomers of methacrylic acid, and
   63.6% of macromonomers which are a methacrylic ester of poly (ethylene oxide) with an average molecular weight of 2000 g/mol and having a methyl group at the end chain.
Test 4: comb copolymer 100% neutralized with sodium hydroxide (molecular weight: 35 000 g/mol)
The polymer has the following composition (in % by weight):
   2.1% of monomers of acrylic acid,
   21.9% of monomers of methacrylic acid, and
   76% of macromonomers which are a methacrylic ester of poly (ethylene oxide) with an average molecular weight of 2000 g/mol and having a methyl group at the end chain.
Test 5: comb copolymer 100% neutralized with sodium hydroxide (molecular weight: 18 500 g/mol)
The polymer has the following composition (in % by weight):
   4.0% of monomers of acrylic acid,
   26.7% of monomers of methacrylic acid, and
   69.3% of macromonomers which are a methacrylic ester of poly (ethylene oxide and propylene oxide) with about 2 units of PO and 43 units of EO with an average molecular weight of 2000 g/mol and having an hydrogen atom at the end chain.

Test 6 and 7 illustrate the use of a comb polymer marketed under the brand name of Melpers® (BASF company) having a specific charge of more than −200 C/g (i.e. −169 C/g and −170 C/g), respectively MelPers® 2450 and MelPers® 4343 to be more precise.

Ground calcium carbonate (GCC) aqueous slurries, at 71±1% solids content, are prepared in this example. 0.6% by dry weight of a polymer (tests 1 to 7), based on the total weight of the solids in the slurry, is introduced into a vessel containing two litres of water. Then 5 kg of ground calcium carbonate, marble of Italian origin, are introduced under agitation into the vessel.

The suspensions are then introduced into a 1.4-liter horizontal grinding mill (Dynomill®) so as to grind the carbonate.

The grinding is stopped when an end product having a particle size distribution such that about 60±1% by weight of the particles have an equivalent spherical diameter less than 2 μm is obtained.

Particle size distribution, and more generally granulometric characteristics of calcium carbonate particles are determined via a sedimentation method determined from a Sedigraph™ 5100 device, sold by MICROMERITICS™ company, i.e. an analysis of the sedimentation behaviour in a gravimetric field. The method and the instrument are known to the skilled person and are commonly used to determine grain size of fillers and pigments.

The polymers used in example 1 have the following characteristics:

TABLE 1

| | | Specific Charge | |
|---|---|---|---|
| Test number | Cloud point (° C.) | (C/g dry polymer) | Δηₛₚ |
| 1 | >100 | −925 | 0.04 |
| 2 | >100 | −494 | 0.18 |
| 3 | >100 | −337 | 0.28 |
| 4 | >95 | −279 | 0.43 |
| 5 | >100 | −330 | 0.43 |
| 6 | >100 | −169 | 0.27 |
| 7 | >100 | −170 | 0.34 |

Viscosity at Different Temperatures

The viscosity of each slurries is measured at 20° C. and 90° C. with a HAAKE RheoStress 600 rheometer (Thermo Electro Corporation) equipped with a DC 60/2° Ti (222-1229) and MP/DC 60 L (222-1546) measuring system. The reported viscosity values are measured at 20 s-1 shear rate. The temperature automatically varies between 20° C. and 90° C. with a Universal Temperature Controller. To avoid evaporation at the surface of the slurry, the system is sealed with a silicone grease and is covered with a thin layer of mineral oil (Aldrich article number: 33,077-9).

TABLE 2

Viscosity aqueous
slurry 20 s⁻¹
(mPa · s)

| Test number | 20° C. | 90° C. |
|---|---|---|
| 1 | 70 | 150 |
| 2 | 30 | 30 |
| 3 | 30 | 20 |
| 4 | 30 | 90 |
| 5 | 30 | 90 |
| 6 | 30 | 90 |
| 7 | 50 | 540 |

The results from Table 2 show that all the polymers of tests 1 to 7 allow to manage the viscosity of the CaCO3 (GCC) slurries heated to 20° C. and 90° C.

The polymer of test 1 has a highly negative specific charge, which has an great influence on the surfacial charge of CaCO3 particles. This can constitute a major problem within certain applications, for example while preparing sheet of paper or for paper coating (bad interaction between paper cellulose, charge retention problems when coating paper). It is then necessary to neutralized the particles by adding cationic additives.

The polymers of tests 2 to 7 have a specific charge comprised between −10 and −600 C/g at pH 8. The use of such polymers solve the above-mentioned problems while allowing to prepare aqueous CaCO3 slurries having a reduced heat sensitivity. Such slurries can then be used in various applications, notable for preparing sheets of paper and for paper coating.

### Example 2

This example illustrates the use of different polymers (test 8 to 11) in the preparation of a GCC aqueous slurry at 75% solid content with a particle size distribution such that about 90±1% by weight of the particles have an equivalent spherical diameter less than 2 μm.

Test 8/8a illustrates the use of a comb polymer outside the scope of the present invention in the preparation of a GCC aqueous slurry. This comb polymer is 100% neutralized with sodium hydroxide (molecular weight: 37 500 g/mol).

The polymer has the following composition (wt. %):
13.7% of monomers of acrylic acid,
6.6% of monomers of methacrylic acid and
79.7% of macromonomers which are methacrylic ester of poly(ethylene oxide) having an average molecular weight of 2 000 g/mol and having a methyl group at the end chain.

Test 9 illustrates the use of a comb polymer as defined by the present invention in the preparation of a GCC aqueous slurry. This comb polymer is 100% neutralized with sodium hydroxide (molecular weight: 17 900 g/mol).

The polymer has the following composition (wt. %):
4.7% of monomers of acrylic acid,
31.7% of monomers of methacrylic acid and
63.6% of macromonomers which are methacrylic ester of poly(ethylene oxide) having an average molecular weight of 2 000 g/mol and having a methyl group at the end chain.

Test 10/10a and 11/11 a illustrate the use of comb polymers marketed under the brand name of Melpers® (BASF company) having a specific charge of more than −200 C/g (i.e. −169 C/g and −170 C/g), respectively MelPers® 2450 and MelPers® 4343 to be more precise.

Various ground calcium carbonate (GCC) aqueous slurries, each at 75±1% solids content, are prepared in this example. 1% by dry weight of a polymer according to test 8, 9, 10 or 11, or 1.2% by dry weight of a polymer according to test 8a and 10a, based on the total weight of the solids in the slurry, is introduced into a vessel containing two litres of water. Then 5 kg of ground calcium carbonate, marble of Italian origin, are introduced under agitation into the vessel.

The specific charge, the cloud point and the specific viscosity as well as the molecular weight of the polymers are measured as the methods indicated in Example 1.

The suspensions are then introduced into a 1.4-liter horizontal grinding mill (Dynomill®) so as to grind the carbonate.

The grinding is stopped when an end product having a particle size distribution such that about 90±1% by weight of the particles have an equivalent spherical diameter of less than 2 μm is obtained.

The polymers used in example 2 have the following characteristics:

TABLE 3

| | Cloud point | Specific Charge | |
|---|---|---|---|
| Test number | (° C.) | (C/g dry polymer) | Δηₛₚ |
| 8 and 8a | nd | −198 | 0.83 |
| 9 | >100 | −337 | 0.28 |
| 10 and 10a | >100 | −169 | 0.26 |
| 11 and 11a | >100 | −170 | 0.35 |

Viscosity at Different Temperatures

The viscosity of each slurries is measured at 20° C. and 90° C. with a HAAKE RheoStress 600 rheometer (Thermo Electro Corporation) equipped with a DC 60/2° Ti (222-1229) and MP/DC 60 L (222-1546) measuring system. The reported viscosity values are measured at 20 s⁻¹ shear rate. The temperature automatically varies between 20° C. and 90° C. with a Universal Temperature Controller. To avoid evaporation at the surface of the slurry, the system is sealed with a silicone grease and is covered with a thin layer of mineral oil (Aldrich article number: 33,077-9).

TABLE 4

Viscosity aqueous
slurry 20 s⁻¹
(mPa · s)

| Test number | 20° C. | 90° C. |
|---|---|---|
| 8 | 370 | 11 540 |
| 8a | 300 | 8 750 |
| 9 | 160 | 180 |
| 10 | 380 | 550 |
| 10a | 200 | 500 |
| 11 | 570 | 1 730 |
| 11a | 1200 | 2300 |

The polymer of test 8 (1 wt. % of polymer (dry %), on the basis of the total quantity of solids in the slurry), outside of scope of the invention since the specific viscosity of said polymer measured at 20° C. and at a polymer concentration of 45 g/l differs from the specific viscosity of said polymer measured at 70° C. by a specific viscosity difference Δηₛₚ, by an absolute value of Δηₛₚ higher than 0.5, does not allow to have a slurry viscosity at 90° C. comprised between 25 and 1 000 mPa·s. Adjusting the content of polymer to 1.2 wt. % (dry %) does not reduce the viscosity at 90° C. below 1 000 mPa·s.

### Example 3

This example illustrates the use of different polymers (test 12 to 16) in the preparation of a GCC aqueous slurry at 75% solids content with a particle size distribution such that about 90±1% by weight of the particles have an equivalent spherical diameter less than 2 μm.

Test 12 illustrates the use of a comb polymer as defined by the present invention in the preparation of a GCC aqueous slurry. This comb polymer is 100% neutralized with sodium hydroxide (molecular weight: 22 250 g/mol, pH: 7.1).

The polymer has the following composition (wt. %):
4.25% of monomers of acrylic acid,
24.0% of monomers of methacrylic acid and
71.75% of macromonomers which are methacrylic ester of poly(ethylene oxide) with an average molecular weight of 2 000 g/mol and having a methyl group at the end chain.

Test 13 illustrates the use of a comb polymer outside the scope of the present invention in the preparation of a GCC aqueous slurry. This comb polymer is 100% neutralized with sodium hydroxide (molecular weight: 37 500 g/mol).

The polymer has the following composition (wt. %):
13.7% of monomers of acrylic acid,
6.6% of monomers of methacrylic acid and
79.7% of macromonomers which are a methacrylic ester having an average molecular weight of 3 000 g/mol and consisting of 70% by weight of poly(ethylene oxide) and 30% by weight of poly(propylene oxide).

Test 14 illustrates the use of a comb polymer outside the scope of the present invention in the preparation of a GCC aqueous slurry. This comb polymer is 100% neutralized with sodium hydroxide (molecular weight: >100 000 g/mol).

The polymer has the following composition (wt. %):
13.7% of monomers of acrylic acid,
6.6% of monomers of methacrylic acid and
79.7% of macromonomers which are a methacrylic ester having an average molecular weight of 3 000 g/mol and consisting of 70% by weight of poly(ethylene oxide) and 30% by weight of poly(propylene oxide).

Test 15 illustrates the use of a comb polymer outside the scope of the present invention in the preparation of a GCC aqueous slurry. This comb polymer is 100% neutralized with sodium hydroxide (molecular weight: >15 600 g/mol, pH: 8.6).

The polymer has the following composition (wt. %):
28.25% of monomers of acrylic acid,
71.75% of macromonomers which are a methacrylic ester of poly(ethylene oxide) with an average molecular weight of 2 000 g/mol and having a methyl group at the end chain.

Test 16 illustrates the use of a comb polymer in the preparation of a GCC aqueous slurry. This comb polymer is 100% acid (molecular weight: 22 250 g/mol, pH: 2.3).

The polymer has the following composition (wt. %):
4.25% of monomers of acrylic acid,
24.0% of monomers of methacrylic acid and
71.75% of macromonomers which are methacrylic ester of poly(ethylene oxide) with an average molecular weight of 2 000 g/mol and having a methyl group at the end chain.

Various ground calcium carbonate (GCC) aqueous slurries, each at 75±1% solids content, are prepared in this example. 1% by dry weight of a polymer according to test 12, based on the total weight of the solids in the slurry, is introduced into a vessel containing two litres of water. Then 5 kg of ground calcium carbonate, marble of Italian origin, are introduced under agitation into the vessel.

The specific charge, the cloud point and the specific viscosity as well as the molecular weight of the polymers are measured as the methods indicated in Example 1.

The suspensions are then introduced into a 1.4-liter horizontal grinding mill (Dynomill®) so as to grind the carbonate.

The grinding is stopped when an end product having a particle size distribution such that about 90±1% by weight of the particles have an equivalent spherical diameter of less than 2 μm is obtained.

The polymers used in example 3 have the following characteristics:

TABLE 5

| | | Specific charge | |
|---|---|---|---|
| Test | Cloud point (° C.) | (C/g dry polymer) | Δηₛₚ |
| 12 | >95 | −315 | 0.48 |
| 13 | 22 | −223 | 0.5 |
| 14 | 22 | −207 | 0.83 |
| 15 | >95 | −328 | 0.37 |
| 16 | >95 | −315 | 0.48 |

Viscosity at Different Temperatures

The viscosity of each slurries is measured at 20° C. and 90° C. with a HAAKE RheoStress 600 rheometer (Thermo Electro Corporation) equipped with a DC 60/2° Ti (222-1229) and MP/DC 60 L (222-1546) measuring system. The reported viscosity values are measured at 20 s-1 shear rate. The temperature automatically varies between 20° C. and 90° C. with a Universal Temperature Controller. To avoid evaporation at the surface of the slurry, the system is sealed with a silicone grease and is covered with a thin layer of mineral oil (Aldrich article number: 33,077-9).

TABLE 6

Viscosity of
the aqueous
slurry at 20 s⁻¹
(mPa · s)

| Test | 20° C. | 90° C. | Observations |
|---|---|---|---|
| 12 | 255 | 255 | — |
| 13 | nd | nd | Grinding not |
| | | | finished, |
| | | | pressure rising in |
| | | | the grinder |
| 14 | nd | nd | Suspension |
| | | | impossible |
| 15 | 466 | 738 | Grinding not |
| | | | finished, |
| | | | pressure rising in |
| | | | the grinder |
| 16 | 675 | 1220 | — |

The polymers of tests 13 to 15, outside of the invention, do not allow obtaining a concentrated suspension of grinded CaCO3. The polymer of test 16, in neutralized form, does not allow to obtain a CaCO3 suspension according to the invention, that is to say having a viscosity at 90° C. below 1 000 MPa·s.

1.-17. (canceled)

18. A comb copolymer, wherein
the specific viscosity of said copolymer measured at 20° C. and at a copolymer concentration of 45 g/l differs from the specific viscosity of said copolymer measured at 70° C. by a specific viscosity difference Δηₛₚ, wherein the absolute value of Δηₛₚ is less than or equal to 0.5, wherein said copolymer does not have a cloud point between 20° C. and 95° C. measured in water, and
said copolymer has a specific charge from −10 C/g to −600 C/g at pH 8,
said copolymer having:
a negatively-charged backbone consisting of polymerized monomers of acrylic acid and methacrylic acid and wherein the percentage by weight of monomers of methacrylic acid is higher than the percentage by weight of monomers of acrylic acid and
non-charged side chains consisting of polymerized epoxide-containing compounds.

19. In a method of reducing the temperature sensitivity of an aqueous slurry comprising water and calcium carbonate by adding an agent thereto, the improvement wherein said agent is a comb copolymer, wherein
the specific viscosity of said comb copolymer measured at 20° C. and at a concentration of 45 g/l differs from the specific viscosity of said comb copolymer measured at 70° C. by a specific viscosity difference Δηₛₚ, wherein the absolute value of Δηₛₚ is less than or equal to 0.5,
said comb copolymer does not have a cloud point between 20° C. and 95° C. measured in water,
said comb copolymer has a specific charge from −10 C/g to −600 C/g at pH 8,
and wherein the comb copolymer is present in said slurry in an amount sufficient to provide said slurry with a viscosity at 20 s⁻¹ ranging from 25 to 1000 mPa·s measured at 20° C. and at 90° C.

20. The method according to claim 19, wherein said copolymer has a specific charge from −10 C/g to −550 C/g at pH 8.

21. The method according to claim 19, wherein said copolymer has a negatively-charged backbone consisting in randomly polymerized monomers of acrylic acid and methacrylic acid and wherein the percentage by weight of monomers of methacrylic acid is more than the percentage by weight of monomers of acrylic acid and non-charged side chains consisting in polymerized epoxide-containing compounds.

22. The method according to claim 19, wherein said comb copolymer comprises:
a) acrylic acid and methacrylic acid monomers, wherein the percentage by weight of monomers of methacrylic acid is higher than the percentage by weight of monomers of acrylic acid, and
b) at least one macromonomer of formula (I):
R-X-R′ (I)
wherein
X represents m units of propylene oxide (PO) and n units of ethylene oxide (EO), said units being disposed either randomly or statistically, wherein m and n are integers less than or equal to 150, with at least one of them being non-zero,
R designates a polymerizable unsaturated function, and
R′ represents hydrogen or an alkyl group from 1 to 4 carbon atoms.

23. The method according to claim 22, wherein R designates the methacrylate function, the methacrylurethane function, the acrylate function, the vinyl function or the allyl function.

24. The method according to claim 22, wherein said comb copolymer consists of, expressed as a percentage by weight of each of its components:
a) from 5 to 60 wt. % of acrylic acid monomers and methacrylic acid monomers, and
b) from 40 to 95 wt. % of at least one macromonomer of formula (I).

25. The method according to claim 22, wherein said comb copolymer consists of, expressed as a percentage by weight of each of its components:
A1) from 1 to 10 wt. % of acrylic acid monomers,
A2) from 10 to 50 wt. % of methacrylic acid monomers, and
B) from 40 to 90 wt. %, of one or more macromonomers with formula (I).

26. The method according to claim 22, wherein said comb copolymer consists of, expressed as a percentage by weight of each of its components:
A1) from 3 to 6% wt. of acrylic acid monomers,
A2) from 20 to 25 wt. % of methacrylic acid monomers, and
B) from 70 to 77 wt. %, of one or more macromonomers with formula (I).

27. The method according to claim 22, wherein m ranges from 0 to 10.

28. The method according to claim 22, wherein n ranges from 10 to 150.

29. The method according to claim 22, wherein n and m are such that n+m is more than or equal to 17.

30. The method according to claim 19, wherein said comb copolymer is present in an amount from 0.01 to 10 wt. %, based on the total weight of the solids in the slurry.

31. The method according to claim 19, wherein said slurry has a particle size distribution such that about 60% by weight of the particles have an equivalent diameter of less than or equal to 2 μm.

32. The method according to claim 19, wherein said comb copolymer has a molecular weight below 100,000 g/mol.

33. The method according to claim 19, wherein said comb copolymer is partially or totally neutralized.
